(19) United States
(12) Patent Application Publication
(10) Pub. No.: US 2025/0206431 A1
(43) Pub. Date: Jun. 26, 2025

(54) PERSONAL WATERCRAFT AND CONTROLLING METHOD OF THE SAME

(71) Applicant: NHK SPRING CO., LTD., Yokohama-shi (JP)

(72) Inventor: Minoru KOMIYA, Yokohama-shi (JP)

(73) Assignee: NHK SPRING CO., LTD., Yokohama-shi (JP)

(21) Appl. No.: 18/988,056

(22) Filed: Dec. 19, 2024

(30) Foreign Application Priority Data
Dec. 22, 2023 (JP) 2023-216622

(51) Int. Cl. B63H 21/21; B63H 21/38; B63H 25/02; F02D 35/00

(52) U.S. Cl. CPC B63H 21/21; B63H 21/38; B63H 25/02; F02D 35/00

(57) ABSTRACT

According to an embodiment a personal watercraft includes a hull, an engine, a steering device, a water jetting nozzle, a control unit, a throttle mechanism, and a detection unit including an inertial measurement unit. When the hull turns, an angular velocity and an angular acceleration around a yaw axis are detected by the inertial measurement unit. When at least one of the angular velocity and the angular acceleration exceeds each threshold value, a deceleration control for decelerating the engine is performed by the control unit.

### CROSS-REFERENCE TO RELATED APPLICATIONS

This application is based upon and claims the benefit of priority from prior Japanese Patent Application No. 2023-216622, filed Dec. 22, 2023, the entire contents of which are incorporated herein by reference.

### BACKGROUND OF THE INVENTION

### 1. Field of the Invention

The present invention relates to personal watercraft such as a water motorcycle and a small outboard motor and a controlling method of the same.

### 2. Description of the Related Art

Examples of personal watercrafts (abbreviated to PWC) include small boats also called water motorcycles or jet-propelled boats. Especially, personal watercrafts that are propelled by jet thrust are capable of not only traveling at high speed but also turning at small turning radii and changing their speed quickly. Thus, the personal watercrafts are excellent in their mobility and agility and thus are expected to be useful in various situations. For example, in the field of water-based leisure activities, the personal watercrafts can be not only operated in a normal driving but also maneuvered in acrobatic manners.

In this specification, the term “turn” is a concept that includes not only changes in courses that change the direction of a hull by nearly 180 degrees such as a U-turn but also changes in courses at other angles. For example, a full turn at angles more than 360 degrees or a turn at an angle less than 360 degrees or at an obtuse angle less than or equal to 90 degrees are included as well. That is, in this specification, a turn means changes in courses that may cause skidding.

Turns of the personal watercraft at the high speed may cause skidding. The factors that cause skidding are not limited to boat speed and turning radii. For example, sea conditions such as waves, wind, and currents can be factors as well. Therefore, a certain boat speed and turning radii may cause skidding or may not cause skidding depending on sea conditions. Once skidding occurs, a hull may face an unintended direction, spin, or fail to turn a curve properly and thus make a wide turn on the curve. In addition, skidding may cause operators to lose their posture or change the hull's posture significantly.

FIG. 8 is a plan view schematically showing examples of respective three types of wakes made by a turn of a personal watercraft. A wake M1 in FIG. 8 shows a case where a hull 1 turns normally without skidding. A wake M2 shows a case where the hull 1 skids and then spins due to a gradual increase in degrees of skidding, and thus loses its control. A wake M3 shows a case where the hull 1 continues turning in a skidded posture and thus makes a wide turn. The occurrence of skidding also depends on the skill of the operator and the sea conditions such as waves. Although a certain degree of skidding is acceptable, large degrees of skidding is preferably suppressed.

In order to stabilize the posture of the hull in traveling, small boats having additional configurations such as a configuration in which a sponson is attached to a side of the hull and a configuration in which a trim tab is controlled are known. These small boats having additional configurations can travel in a stable manner but also suppress agile turns. It is possible to some degrees to find a compromise between the stability and the turning capability by changing the size and shape of sponsons. However, it is difficult to use such additional configurations flexibly according to the purpose of the use and sea conditions.

The small boat described in JP H9-86484 A (Patent Literature 1) has a means of suppressing skidding in a turn. The small boat controls the exhaust duct for jet thrust according to the amount of rotations of the steering device. For example, the control valve is provided in the exhaust duct. This control valve is operated by the valve driving means operating in association with the steering device.

The small boat described in JP 2021-75133 A (Patent Literature 2) detects the engine speed or the opening degree of the throttle and controls the trim angle based on the detected signal. For example, at the start of a turn, the trim actuator activates the deflector to reduce the trim angle of the hull, thereby suppressing an increase in the turning radii.

The jet-propelled boat described in U.S. Pat. No. 9,623,943 B2 (Patent Literature 3) includes the turning state determination section for determining the turning state of the hull. The turning state determination section detects the turning state of the hull based on the operation angle of the steering member, the traveling speed, the engine speed, and the like. When the turning state is determined to be the turning state of the high-speed traveling, the engine speed is reduced.

These conventional small boats described in Patent Literatures 1, 2, 3, and the like predict the occurrence of skidding based on data such as the operation angle of the steering device, the engine speed, the boat speed, and the like. However, the occurrence of skidding depends on sea conditions such as waves, wind, and currents. For example, skidding occurs in some cases depending on conditions of waves and wind hitting the hall in a turn.

Therefore, even when skidding is predicted based on the operation angle of the steering device, the engine speed, the boat speed, and the like, a failure to address ever-changing sea conditions may lead to unexpected skidding. However, when a control that uniformly suppresses skidding regardless of the skill of the operator or the sea conditions is performed, the boat speed in a turn is decreased more than necessary and thus the turning radii becomes larger. Such a control is not preferable.

Other conventional examples include small boats including capsizing sensors. When a small boat including a capsizing sensor loses control of its hull due to skidding and the like, the capsizing sensor that has detected capsizing outputs a signal to stop the engine in this capsized state. However, even the capsizing sensor cannot suppress skidding itself.

The embodiments of the present invention aim to provide the personal watercrafts capable of suppressing skidding, which is caused at the time of operating the steering, without suppressing boat speed in a turn more than necessary and the control method of the same.

### BRIEF SUMMARY OF THE INVENTION

One embodiment is a personal watercraft comprising a hull, an engine mounted on the hull, a fuel supply mechanism such as a throttle mechanism for controlling a rotation of the engine, and a steering device for steering. The fuel supply mechanism may be a fuel injection system comprising a fuel injection valve, a fuel injection pump, and the like. Furthermore, the personal watercraft comprises a detection unit and a control unit. The detection unit includes a sensor detecting at least one of an angular velocity and an angular acceleration around a yaw axis of the hull. The control unit performs a deceleration control of the engine when the angular velocity or the angular acceleration around the yaw axis detected by the detection unit exceeds each threshold value in a turn of the hull. The threshold value of the angular velocity and the threshold value of the angular acceleration are different from each other.

In the personal watercraft of the present embodiment, in a turn of the hull in a direction, the control unit performs a first-time deceleration control based on the angular acceleration. Further, in the turn of the hull in the same direction as the first-time deceleration control, second-and-subsequent deceleration controls may be performed based on the angular velocity. The detection unit may include an inertial measurement unit (IMU). This inertial measurement unit detects an angular velocity and an angular acceleration in a role direction, an angular velocity and an angular acceleration in a pitch direction, and an angular velocity and an angular acceleration around a yaw axis. The control unit may perform the deceleration control based on at least one of the angular velocity and the angular acceleration around the yaw axis.

A controlling method of a personal watercraft of an embodiment of the present invention detects at least one of the angular velocity and the angular acceleration around the yaw axis with the hull turning, and when a detected angular velocity or a detected angular acceleration exceeds each threshold value, performs a deceleration control to decelerate the engine.

In the control method of the embodiment, the angular velocity and the angular acceleration around the yaw axis of the hull are detected. In a turn of the hull in a direction, a first-time deceleration control is then performed based on the angular acceleration. Furthermore, in the turn of the hull in the same direction as the first-time deceleration control, second-and-subsequent deceleration controls may be performed based on the angular velocity.

The personal watercraft and the control method of the present invention can suppress skidding that occurs in a turn and prevent the boat speed in a turn from being reduced more than necessary.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a personal watercraft of an embodiment.

FIG. 2 is a side view of the personal watercraft shown in FIG. 1.

FIG. 3 is a time chart showing the relationship between various electrical signals and time in the personal watercraft shown in FIG. 1.

FIG. 4 is a flowchart showing the flow of a skidding suppression processing for the personal watercraft shown in FIG. 1.

FIG. 5 is a time chart showing the relationship between various electrical signals and time in a personal watercraft of a comparative example.

FIG. 6 is a time chart showing the relationship between various electrical signals and time in a personal watercraft of the second embodiment.

FIG. 7 is a flowchart showing the flow of a skidding suppression processing for the personal watercraft shown in FIG. 6.

FIG. 8 is a plan view schematically showing examples of respective three types of wakes made by a turn of a conventional personal watercraft, including that of a related art.

### DETAILED DESCRIPTION OF THE INVENTION

### First Embodiment

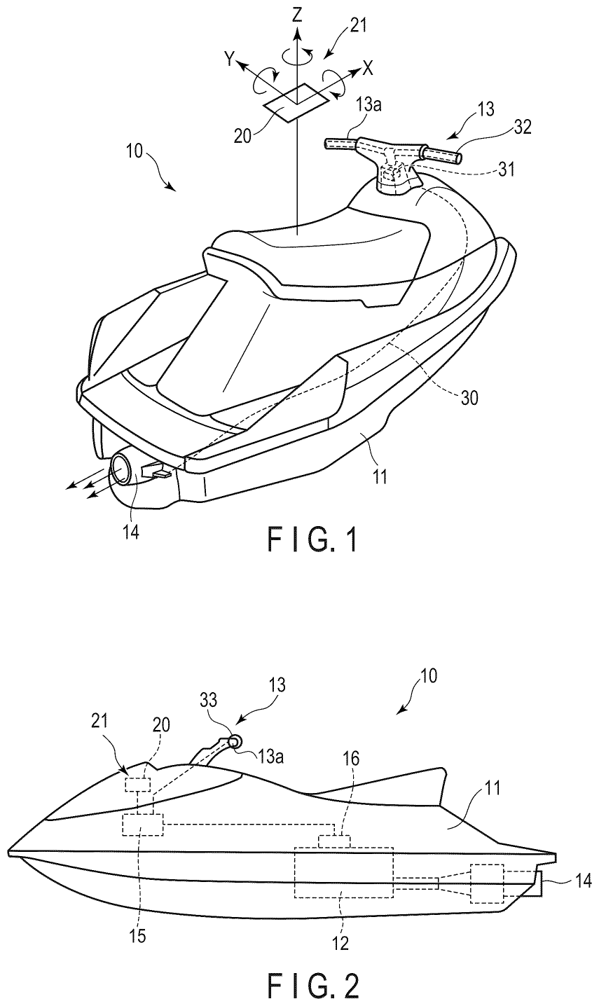

The following describes a personal watercraft and a controlling method of the same of the first embodiment with reference to FIG. 1 to FIG. 4.

FIG. 1 shows a personal watercraft (called a water-motorcycle as well) 10 as an example of a small boat. FIG. 2 is a side view of the personal watercraft 10.

The personal watercraft 10 of the present

embodiment includes: a hull 11; an engine 12 mounted on the hull 11; a steering device 13 for steering; a water jetting nozzle 14; a control unit (a controller) 15; a throttle mechanism 16; a detection unit 21 including an inertial measurement unit (IMU) 20; and the like. The water jetting nozzle 14 is arranged at the rear of the hull 11. The control unit 15 includes electrical circuits for controlling the engine 12. The throttle mechanism 16 is an example of a fuel supply mechanism. Other examples of the fuel supply mechanism include fuel injection systems comprising fuel injection valves, fuel injection pumps, and the like.

The rotation of an impeller by the engine 12 makes the water jetting nozzle 14 jet water flow, which is for jet thrust, into water. The throttle mechanism 16 controls the rotation of the engine 12. In other words, when the opening degree of the throttle mechanism 16 (referred to as a throttle opening degree as well) is large, the engine 12 rotates at high speed, and when the throttle opening degree is small, the engine 12 rotates at low speed. In a case of an engine using the fuel injection valve, the engine 12 rotates at low speed by reducing the amount of injected fuel. As an example of the engine deceleration control, the fuel cut or the ignition cut may be adopted.

The steering device 13 includes a steering member 13a and a steering cable 30. The steering cable 30 transmits the movement of the steering member 13a to the water jetting nozzle 14. When the steering member 13a is turned to the right or left, the direction of the water jetting nozzle 14 is changed via the steering cable 30. This can change the direction of the hull 11. The operation direction and the operation angle of the steering member 13a are detected by a steering sensor 31 (shown in FIG. 1).

The steering member 13a includes an accelerator control unit 32 for operating the accelerator and an accelerator sensor 33. When the accelerator control unit 32 is manually operated, a signal to control the opening degree of the accelerator is output from the accelerator sensor 33 to the control unit 15 according to the amount of this manual operation. The control unit 15 changes the opening degree of the accelerator of the throttle mechanism 16 based on this accelerator control signal.

The detection unit 21 includes the inertial measurement unit 20. As shown in FIG. 1, the inertial measurement unit 20 has a function of detecting the acceleration in the axis direction and the angular velocity around the axis of each of the X-axis, Y-axis, and Z-axis, which are orthogonal to one another. In other words, the inertial measurement unit 20 detects the acceleration in the X-axis direction and the angular velocity around the X-axis, the acceleration in the Y-axis direction and the angular velocity around the Y-axis, and the acceleration in the Z-axis direction and the angular velocity around the Z-axis. The electrical signals related to the acceleration detected by the inertial measurement unit 20 and the electrical signals related to the angular velocity are input to the control unit 15.

The X-axis of the inertial measurement unit 20 extends in the fore-and-aft direction of the hull 11. In other words, the rotation around the X-axis is the direction along which the hull 11 rolls (a roll direction). The Y-axis extends in the width direction of the hull 11. The rotation around the Y-axis is the direction along which the hull 11 pitches (a pitch direction). The Z-axis extends in the vertical direction of the hull 11. The rotation around the Z-axis is a yaw direction of the hull 11. In this specification, a rotation in the yaw direction is referred to as a rotation around the yaw axis in some cases.

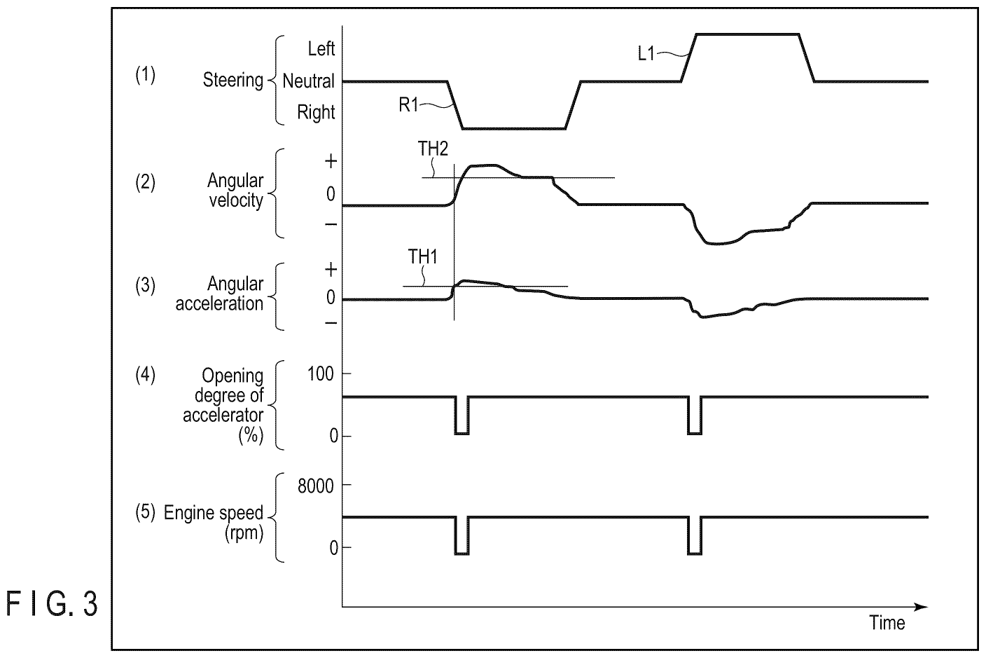

FIG. 3 is a time chart showing an example of the relationship between various electrical signals and time when the personal watercraft 10 of the present embodiment is traveling. The details of items (1) to (5) in FIG. 3 are as follows.
(1) [Steering] indicates the steering direction (right or left) detected by the steering sensor 31 at the time of operating the steering member 13a.
(2) [Angular Velocity] indicates a change with the passage of time in the angular velocity in the yaw direction (around the Z-axis) detected by the inertial measurement unit 20 in a turn of the hull 11.
(3) [Angular Acceleration] indicates a change with the passage of time in the angular acceleration calculated from the angular velocity in the yaw direction (around the Z-axis) detected by the inertial measurement unit 20 in a turn of the hull 11.
(4) [Opening Degree of Accelerator] indicates a change with the passage of time in an accelerator control signal output from the control unit 15 to the engine 12 with the accelerator control unit 32 being operated by an operator. However, the amount of operations of the accelerator control unit 32 and the accelerator control signals output from the control unit 15 to the engine 12 may be different from each other.
(5) [Engine Speed] indicates a change with the passage of time in the speed of the engine 12.

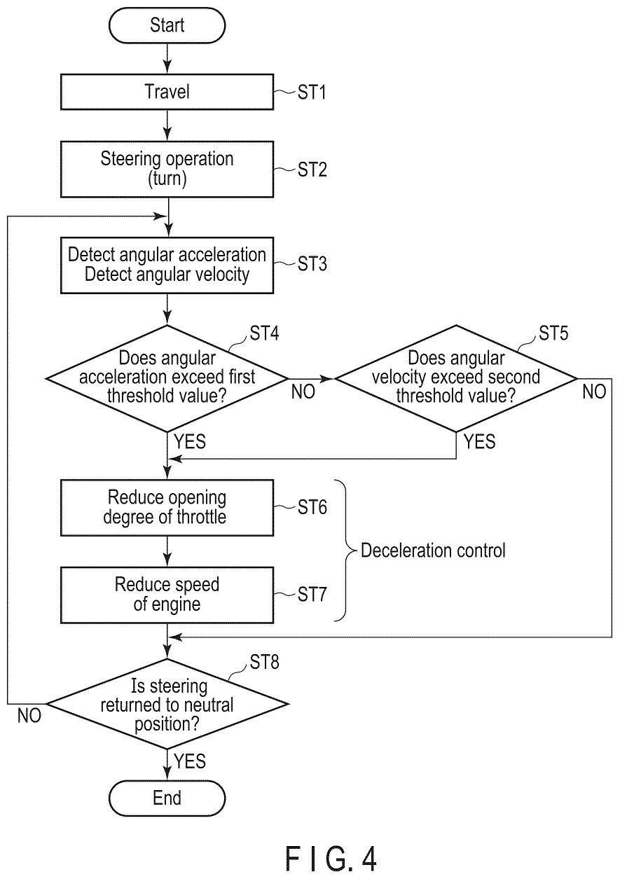

Next, an example of the method of controlling the personal watercraft 10 of the present embodiment will be described with reference to FIG. 3 and FIG. 4. FIG. 4 is a flowchart showing the flow of the skidding suppression processing for the personal watercraft 10 of the first embodiment. The skidding suppression processing is performed based on computer program stored in the control unit 15, outputs from the inertial measurement unit 20, and the like.

In a step ST1 in FIG. 4, the steering is substantially in the neutral position. Thus, the personal watercraft 10 substantially moves straight. In a step ST2, the steering member 13a is turned to the right or left by the operator.

For example, turning the steering member 13a to the right as shown by R1 in (1) [Steering] in FIG. 3 makes the hull 11 turn to the right. At the time of this turn, the angular velocity is generated as shown in (2) [Angular Velocity] in FIG. 3, and the angular acceleration is generated as shown in (3) [Angular Acceleration]. The rise in the angular acceleration is faster than the rise in the angular velocity. Furthermore, skidding of the hull 11 in a turn generates a larger angular velocity and a larger angular acceleration, compared to a case where no skidding occurs.

In a step ST3 in FIG. 4, the angular velocity is detected and the angular acceleration is detected, and then the process proceeds to a step ST4. In the step ST4, it is determined whether or not the angular acceleration exceeds a first threshold value TH1. When the angular acceleration exceeds the first threshold value TH1 (“YES” in the step ST4), the process proceeds to a step ST6. In the step ST6, the deceleration control of the engine 12 is performed by the control unit 15 outputting a signal to reduce the opening degree of the throttle to the engine 12. As an example of the engine deceleration control, the ignition cut may be adopted. In a case of an engine using a fuel injection valve, a control for reducing the amount of the injected fuel or the fuel cut may be performed.

When the angular acceleration does not exceed the first threshold value TH1 (“NO” in the step ST4), the process proceeds to a step ST5. In the step ST5, it is determined whether or not the angular velocity exceeds a second threshold value TH2. When the angular velocity exceeds the second threshold value TH2 (“YES” in the step ST5), the process proceeds to the step ST6. In the step ST6, the deceleration control of the engine 12 is performed by the control unit 15 outputting a signal to reduce the opening degree of the throttle to the engine 12. The first threshold value TH1 of the angular acceleration and the second threshold value TH2 of the angular velocity are different from each other.

In the step ST6, for example, the deceleration control to reduce the opening degree of the throttle to be close to zero is performed, as shown in (4) [Opening Degree of Accelerator] in FIG. 3. When the opening degree of the throttle becomes closer to zero, the engine speed rapidly decreases in a step ST7. As a result, as shown in (5) [Engine Speed] in FIG. 3, as the engine speed becomes closer to zero, the thrust decreases and thus skidding is suppressed.

In a step ST8 in FIG. 4, the skidding suppression processing ends when the steering member 13a is returned to the neutral position (“YES” in the step 8). In a case where the steering member 13a is not returned to the neutral position (“NO” in the step ST8), the process returns to the step ST3 and the skidding suppression processing performed in the steps ST3 to ST7 is repeated.

As indicated by L1 in (1) [Steering] in FIG. 3, turning the steering member 13a to the left makes the hull 11 turn to the left. In this case as well, the skidding suppression processing shown in the steps ST3 to ST7 in FIG. 4 is performed, and the skidding in the left turn is suppressed as in the case of that in the right turn.

Once skidding occurs and thus the hull's posture becomes unstable, addressing skidding is difficult in some cases. The inventors of the present invention therefore focused on that the rise in the angular acceleration is faster than the rise in the angular velocity at the start of skidding. In other words, in the step ST4, the rise in the angular acceleration at the start of skidding is detected. Then, when the angular acceleration exceeds the first threshold value TH1, the process proceeds to the deceleration control to be performed in the step ST6 and the subsequent steps. This configuration allows the deceleration control to start before skidding becoming large. However, depending on situations, the process may proceed to the deceleration control in the step ST6 based on the magnitude of the angular velocity, as shown in the step ST5. The control unit of the present embodiment performs the deceleration control of the engine when the angular velocity or the angular acceleration around the yaw axis detected by the detection unit in a turning of the hull exceeds the respective threshold values. That is, the deceleration control of the engine is performed when the angular acceleration exceeds the first threshold value or the angular velocity exceeds the second threshold value. The first threshold value and the second threshold value are different from each other.

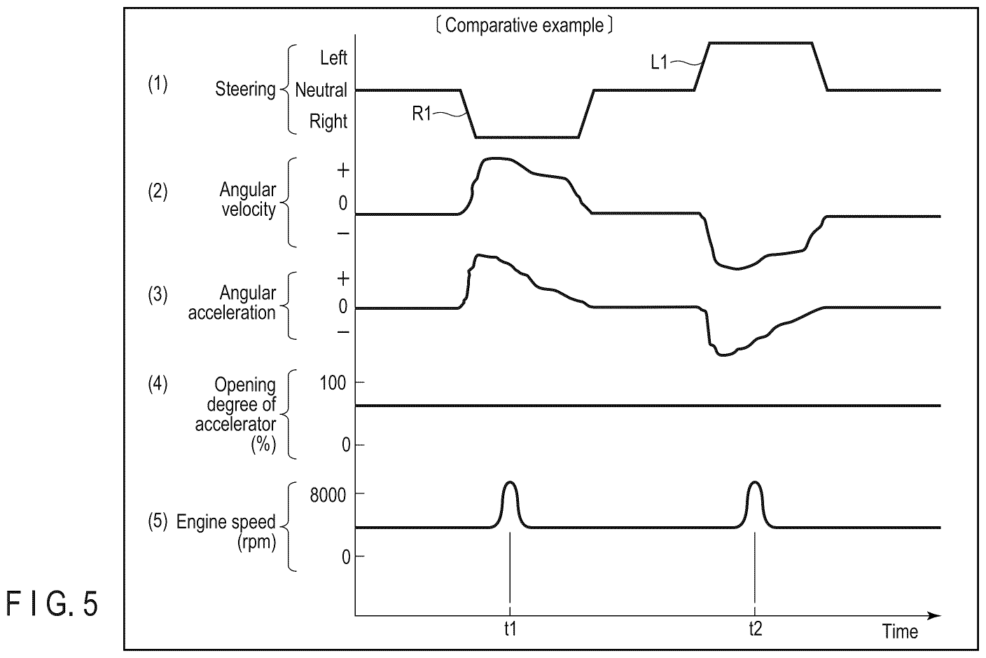

For reference, a comparative example shown in FIG. 5 will be described.

### Comparative Example

FIG. 5 is a time chart of a comparative

example examined by the present inventors in the course of developing the personal watercraft. The personal watercraft of the comparative example also includes the inertial measurement unit and detects the angular velocity and the angular acceleration. However, the personal watercraft of the comparative example does not perform the skidding suppression processing described in the first embodiment. This comparative example was examined in private and thus is not publicly known.

Items (1) to (5) in FIG. 5 are the same as those in FIG. 3. Therefore, the explanations on these items (1) to (5) are omitted.

As shown by R1 in (1) [Steering] in FIG. 5, turning the steering member to the right makes the hull turn to the right. At the time of this turn, the angular velocity is generated as shown in (2) [Angular Velocity] in FIG. 5 and the angular acceleration is generated as shown in (3) [Angular Acceleration] in FIG. 5. In particular, when skidding occurs in the turn, the large angular velocity and the large angular acceleration are generated.

In (4) [Opening Degree of Accelerator] in FIG. 5, for example, the opening degree of the accelerator is kept constant, as in a case of auto cruise control. When skidding occurs and thus the inclination of the hull in the roll direction increases, the position of the water intake for jet thrust and the like become disadvantageous compared to normal conditions. As a result, as indicated by time t1 and time t2 in (5) [Engine Speed] in FIG. 5, the engine becomes in idling state to some degrees, causing a temporary revving up of the engine. The skidding suppression processing is not performed in this comparative example. Thus, in the comparative example, the hull and the operator may lose their postures and the engine may rev up.

### Second Embodiment

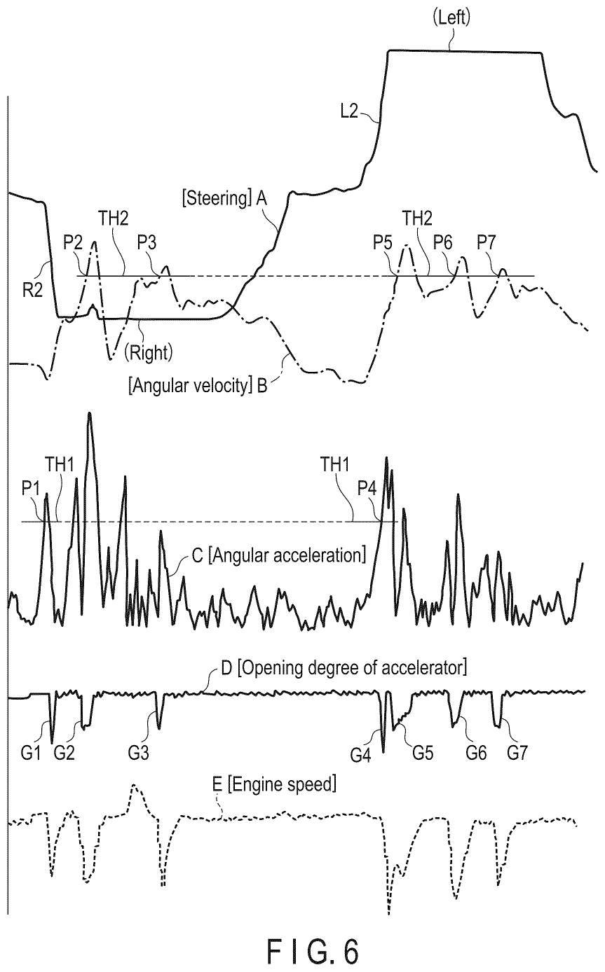

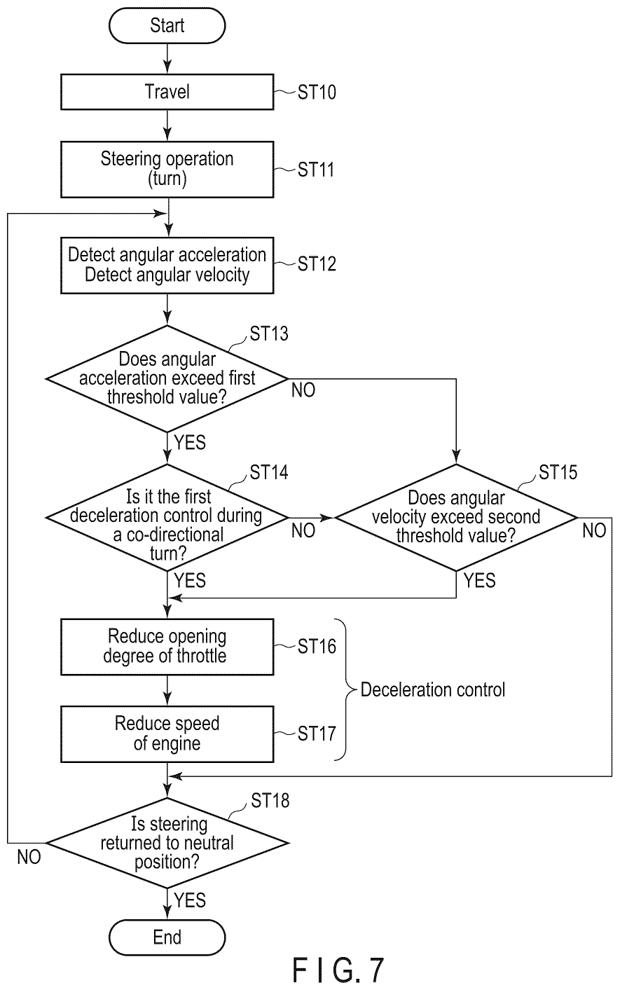

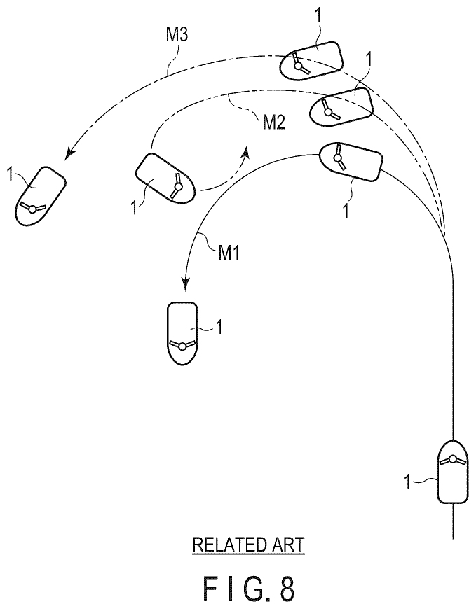

The following describes a controlling method of a personal watercraft of the second embodiment with reference to FIG. 6 to FIG. 7. The constituent elements of the personal watercraft of the second embodiment are the same as those of the personal watercraft 10 of the first embodiment (shown in FIG. 1 and FIG. 2). Therefore, in the second embodiment, common reference numbers are added to the structural elements common to the personal watercraft 10 of the first embodiment and that in the second embodiment, and explanations thereof are omitted. The personal watercraft of the second embodiment also includes an inertial measurement unit 20.

FIG. 6 is a time chart showing the relationship between various electrical signals and time in a turn of the personal watercraft of the second embodiment. The following will explain the items in FIG. 6 from the top item to the bottom item in order. Line Segment A [Steering] indicates a direction of the operation (right or left) detected by a steering sensor 31 at the time of operating the steering member 13a.

Line Segment B [Angular Velocity] in FIG. 6 indicates a change with the passage of time in the absolute value of the angular velocity in the yaw direction (around the Z-axis) detected by the inertial measurement unit 20 in a turn of the hull. Line Segment C [Angular Acceleration] indicates a change with the passage of time in the absolute value of the angular acceleration calculated from the angular velocity in the yaw direction (around the Z-axis) detected by the inertial measurement unit 20 in a turn of the hull.

Line Segment D [Opening Degree of Accelerator] in FIG. 6 indicates a change with the passage of time in accelerator control signals which a control unit 15 outputs to an engine 12 with an accelerator control unit 32 being operated by an operator. However, the amount of operations of the accelerator control unit 32 and the accelerator control signals output from the control unit 15 to the engine 12 may be different from each other. Line Segment E [Engine Speed] indicates a change with the passage of time in the speed of the engine 12.

FIG. 7 is a flowchart showing the flow of the skidding suppression processing for the personal watercraft of the second embodiment. The skidding suppression processing is performed based on computer program stored in the control unit 15, outputs from the inertial measurement unit 20, and the like.

In a step ST10 in FIG. 7, the steering is substantially in the neutral position. Thus, the personal watercraft 10 substantially travels straight. In a step ST11, the steering member 13a is turned to the right or the left by the operator.

For example, as shown by R2 in Line Segment A [Steering] in FIG. 6, turning the steering member 13a to the right makes the hull turn to the right. At the time of this turn, the angular velocity is generated as shown in Line Segment B [Angular Velocity], and the angular acceleration is generated as shown in Line Segment C [Angular Acceleration]. The rise in the angular acceleration is faster than the rise in the angular velocity. Furthermore, skidding of the hull 11 in a turn generates a larger angular velocity and a larger angular acceleration, compared to a case where no skidding occurs.

In a step ST12 in FIG. 7, the angular velocity is detected and the angular acceleration is detected, and then the process proceeds to a step ST13. In the step ST13, it is determined whether or not the angular acceleration exceeds a first threshold value TH1. When the angular acceleration exceeds the first threshold value TH1 (“YES” in the step ST13), the process proceeds to a step ST14. In the step ST14, it is determined whether or not a deceleration control is “a first-time deceleration control” in a turn in a direction. When this deceleration control is the first-time deceleration control (“YES” in the step ST14), the process proceeds to a step ST16, and then the deceleration control is performed. When this deceleration control is second-and-subsequent deceleration controls (“NO” in the step ST14) in the turn in the same direction as the first-time deceleration control, the process proceeds to the step ST15.

In the step ST13, when the angular acceleration does not exceed the first threshold value TH1 (“NO” in the step ST13), the process proceeds to a step ST15. In the step ST15, it is determined whether or not the angular velocity exceeds a second threshold value TH2. When the angular velocity exceeds the second threshold value TH2 (“YES” in the step ST15), the process proceeds to the step ST16, and then the deceleration control is performed.

In the step ST16, for example, the

deceleration control to make the opening degree of the throttle close to zero is performed, as shown in Line Segment D [Opening Degree of Accelerator] in FIG. 6. When the opening degree of the throttle becomes close to zero, the engine speed rapidly decreases in a step ST17. Therefore, as shown in Line Segment E [Engine Speed] in FIG. 6, as the engine speed becomes close to zero, the thrust decreases and thus skidding is suppressed.

In a step ST18 in FIG. 7, it is determined whether or not the steering member 13a is returned to the neutral position. In a case where the steering member 13a is not returned to the neutral position (“NO” in the step ST18), the process returns to the step ST12 and the skidding suppression processing performed in the steps ST12 to ST17 is repeated.

In the example shown in FIG. 6, the steering member is first turned to the right and thus the hull turns to the right. In this right turn, the angular acceleration exceeds the first threshold value TH1 at P1 in Line Segment C [Angular Acceleration], and thus the first-time deceleration control is performed. Thereafter, the angular velocity exceeds the second threshold value TH2 at P2 and P3 in Line Segment B [Angular Velocity], and thus the second-time deceleration control and the third-time deceleration control are performed, respectively in this right turn. That is, as shown in Line Segment D [Opening Degree of Accelerator], three deceleration controls are performed in total in the right turn (deceleration controls G1, G2, and G3).

When it is determined that the steering member 13a is returned to the neutral position in the step ST18 in FIG. 7 (“YES” in the step ST18), the skidding suppression processing ends. Then, the process stops until the steering member 13a is operated in a next turn of the hull.

For example, when the steering member is operated to the left as shown in L2 in Line Segment A [Steering] in FIG. 6 after the steering member being returned to the neutral position, the hull turns to the left. In this left turn, the angular acceleration exceeds the first threshold value TH1 at P4 in Line Segment C [Angular Acceleration], and thus the first-time deceleration control in this left turn is performed. Thereafter, the angular velocity exceeds the second threshold value TH2 at P5, P6, and P7 in Line Segment B [Angular Velocity], and thus the second-and-subsequent deceleration controls in this left turn are performed. That is, as shown in Line Segment D [Opening Degree of Accelerator], four deceleration controls are performed in total in this left turn (deceleration controls G4, G5, G6, and G7).

In this manner, with respect to the skidding suppression processing in the second embodiment, the first-time deceleration control in the turn in a direction proceeds to the step ST16, and the deceleration control based on the angular acceleration is performed. This enables decreasing thrust at the start of skidding and thus effectively suppressing skidding. In the second-and-subsequent deceleration controls, the boat speed has been already reduced to some degrees due to the first-time deceleration control. Thus, the process proceeds to the step ST15 and the deceleration control based on the angular velocity is performed.

When the waveform of Line Segment B [Angular Velocity] and Line Segment C [Angular Acceleration] shown in FIG. 6 are compared to each other, the variation in the angular acceleration is larger than that in the angular velocity. Therefore, when the second-and-subsequent deceleration controls are performed based on the angular acceleration in the turn in the same direction as the first-time deceleration control, the speed of the engine changes frequently. This may make the control of the hull difficult.

Therefore, in the skidding suppression processing in the second embodiment in the turn in the same direction, the first-time deceleration control is performed based on the angular acceleration, and the second-and-subsequent deceleration controls are performed based on the angular velocity. This prevents the engine speed from changing more than necessary in the turn. Further, the deceleration control can be performed at the early stage of skidding.

### Other Embodiments

In a personal watercraft comprising an inertial measurement unit 20, at least one of the angular velocity and the angular acceleration around the X-axis (the roll direction) may be detected to be used in the skidding suppression processing. For example, in the skidding suppression processing described in the second embodiment, information on the angular velocity or the angular acceleration in the roll direction may be considered. Alternatively, the angular velocity and the angular acceleration around the Y-axis (the pitch direction) may be detected to be used in the skidding suppression processing.

In addition to the information on the roll and the pitch of the hull, the velocity of the hull may be detected to be used for the skidding suppression processing (a trigger for the deceleration control). In addition, the combination of information on these items (the roll, the pitch, and the velocity of the hull), the angular velocity, and the angular acceleration may be used to perform the skidding suppression processing. For example, a threshold value of the angular acceleration (the first threshold value TH1) and a threshold value of the angular velocity (the second threshold value TH2) may be changed according to information on the pitch, the roll, and the velocity of the hull, for example.

The personal watercraft comprising a sponson for stabilizing the hull may adopt a movable sponson. In that case, overhang amount of the sponson may be changed to suppress skidding according to the magnitude of the angular velocity or the angular acceleration detected by the inertial measurement unit and the like in a turn.

Personal watercrafts comprising movable trim tabs are also known. In the personal watercrafts comprising the movable trim tabs, a tilt angle of the trim tabs may be varied to suppress skidding according to the magnitude of the angular velocity or the angular acceleration detected by the inertial measurement unit and the like in a turn.

In implementing the present invention, the detection unit is not limited to the inertial measurement unit and may be a sensor that can detect at least the angular velocity and the angular acceleration in the yaw direction. It goes without saying that the constituent elements of the personal watercraft such as the hull, the engine, and the steering device can also be changed as necessary. The skidding suppression processing for the present invention may be adopted in the outboard motors.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A personal watercraft comprising:
a hull;
an engine mounted on the hull;
a fuel supply mechanism configured to control a rotation of the engine;
a steering device for steering;
a detection unit including a sensor configured to detect at least one of an angular velocity and an angular acceleration around a yaw axis of the hull; and
a control unit configured to perform a deceleration control of the engine when the angular velocity or the angular acceleration around the yaw axis detected by the detection unit exceeds each threshold value in a turn of the hull.

2. The personal watercraft of claim 1, wherein
the control unit performs a first-time deceleration control in a turn of the hull in a direction based on the angular acceleration and performs second-and-subsequent deceleration controls in the turn in the same direction as the first-time deceleration control based on the angular velocity.

3. The personal watercraft of claim 1, wherein
the detection unit includes an inertial measurement unit configured to detect an angular velocity and an angular acceleration in a roll direction, an angular velocity and an angular acceleration in a pitch direction, and the angular velocity and the angular acceleration around the yaw axis, and
the control unit is configured to perform the deceleration control based on at least one of the angular velocity and the angular acceleration around the yaw axis.

4. A control method of a personal watercraft comprising a hull, an engine, a fuel supply mechanism, and a steering device, the method comprising:
detecting at least one of an angular velocity and an angular acceleration around a yaw axis with the hull turning; and
performing a deceleration control for decelerating the engine when the angular velocity detected or the angular acceleration detected exceeds each threshold value.

5. The control method of the personal watercraft of claim 4, further comprising:
detecting the angular velocity and the angular acceleration around the yaw axis;
performing a first-time deceleration control in a turn of the hull in a direction based on the angular acceleration; and
performing second-and-subsequent deceleration controls in the turn of the hull in the same direction as the first-time deceleration control based on the angular velocity.
